(19) United States
(12) Patent Application Publication
(10) Pub. No.: US 2005/0233910 A1
(43) Pub. Date: Oct. 20, 2005

(54) Thick films of yba<sb>2</sb>cu<sb>3</sb>o <sb>7-y</sb> and preparation method thereof

(76) Inventors: Philippe Odier, Claix (FR); Supardi Zainul, Surabaya (ID); Francois Florent Weiss, Tourbomot (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/512,063

(22) PCT Filed: Apr. 18, 2003
(86) PCT No.: PCT/FR03/01254

§ 371 Date: Oct. 21, 2004

(30) Foreign Application Priority Data
Apr. 25, 2002 (FR) 02/05217

(51) Int. Cl. H01B 1/00

(52) U.S. Cl. 505/100

(57) ABSTRACT

The invention relates to a method of preparing thick films of YBa₂Cu₃O_{7-y}(y=0.08) having a critical current density of the order of 10⁶ A/cm². The inventive method comprises using an inert carrier gas to send an aerosol, obtained from an aqueous solution of precursors of yttrium nitrate, barium nitrate and copper nitrate (0.11=FY=0.28, 0.46=FBa=0.58, 0.2=FCu=0.37), having a concentration which is essentially equal to the concentration at saturation, to the surface of a heated substrate whereon it undergoes pyrolysis for between 1 and 5 nm at 800° C. and 870° C., followed by oxygen annealing at a temperature which is greater than the pyrolysis temperature by at least 10° C. and between 850° C. and 880° C. for between 1 and 2 hours, and subsequently at 450° C.-550° C. for between 0.5 and 1.5 hours.

The present invention relates to a process for preparing YBa₂Cu₃O_{7-y} thick films and to the thick films obtained.

YBa₂Cu₃O_{7-y} (denoted hereafter by YBCO) is a compound of interest because of its superconducting properties. The main parameters that characterize the superconducting state are the critical temperature (T_{C}), the critical current density (J_{C}) and the critical magnetic field (H_{C}).

The ultrasonic spray pyrolysis process, denoted hereinafter by USP process, is a deposition technique known for synthesizing YBCO films. The USP process consists in spraying a solution containing the precursors of the chemical elements to be deposited, in order to form an aerosol, in transporting the aerosol using a carrier gas at a temperature close to room temperature from its source to a reaction region where it comes into contact with the surface of a heated substrate on which it undergoes pyrolysis.

The precursor solution may be sprayed using various techniques. The ultrasonic technique is preferred as it makes it possible to control the size of the droplets and to produce relatively small (≈3 μm) droplets, with a very homogeneous and narrow size distribution.

The “ex situ” USP process is carried out with a substrate temperature below 500° C. It is therefore absolutely essential for the film obtained to undergo a subsequent heat treatment.

The “in situ” USP process is carried out with a substrate temperature well above 500° C. The subsequent heat treatment is then no longer essential. Various prior publications have reported on in situ USP processes carried out at temperatures between 800° C. and 900° C. T. C. Shields et al., [Supercond. Sci. and Techn. 15 (1) 99-103 (2002)] describe the high-temperature USP synthesis of YBCO on a substrate consisting of an STO (SrTiO₃) single crystal. The aerosol is a 5×10⁻³M solution obtained by introducing, into 0.1M nitric acid, the appropriate amounts of the respective nitrates in such a way that the 1/2/0.5 Y/Ba/Cu stoichiometric ratio is respected. The aerosol is directed onto a substrate heated to a temperature between 800° C. and 900° C., in 30 cycles of 30 seconds each, because of the drop in temperature of the substrate. For STO substrates, the best results were obtained at 850° C.: epitaxial film; T_{C}=91 K; J_{C} around 1.2×10⁵ A/cm² at 77 K.

A. Ferreri et al. (Physica C 351 (2001) 58-61) describe processes for YBCO deposition by USP from solutions of nitrate precursors, the LAO (LaAlO₃) substrate being at a temperature of 900° C. The three precursor nitrates were prepared by dissolving the corresponding oxides in nitric acid. A precursor solution was prepared by mixing the nitrate solutions in proportions such that the overall concentration was 7.5×10⁻³M with a 1/2/0.6 Y/Ba/Cu stoichiometric ratio. Other precursor solutions were prepared with respective overall concentrations of 3.75×10⁻³M, 1.5×10⁻³M and 0.75×10⁻³M. The best properties were obtained for the 1.5×10⁻³M concentration, which gave a good crystalline structure with a microstructure having a certain degree of porosity, but nevertheless with good grain connectivity and a T_{C} of 85 K. A J_{C}>10⁴ A/cm² at 77 K is mentioned in the summary.

J. L. MacManus-Driscoll et al. (“In-plane aligned YBCO thick films grown in situ by high temperature ultrasonic spray pyrolysis”, Supercond. Sci. Technol. 14, (2001) 96-102) describe the deposition of YBCO on various substrates, especially LAO, Ag single crystal, MgO, and Ag in the form of textured polycrystalline sheet. The deposition was carried out by USP, the substrate being at 900° C., using a nitrate solution with a 1/2/0.6 Y/Ba/Cu stoichiometric ratio. The overall nitrate concentrations of the precursor solution were 1×10⁻²M, 7.5×10⁻³M, 3.75×10⁻³M, 1.5×10⁻³M and 0.75×10⁻³M. The best properties were obtained on the films obtained from the most dilute solution. However, the J_{C} at 77 K is not greater than 10⁴ A/cm². The authors of this article recommend the use of more dilute solutions in order to improve the T_{C} and the J_{C} of the thick films obtained, while increasing the duration of the treatment. This is because the objective is to form films having a thickness of a few microns. Now, the size of the drops used in the USP technique is of the order of ten microns. It therefore seems a priori preferable to reduce the precursor concentrations so as to form, after spraying, the smallest possible particles in order to obtain smooth films a few microns in thickness. However, for the same thickness, the deposition times will be longer and the risk of contamination by the substrate will be higher.

Now, the inventors have observed that, contrary to what was suggested by the prior art, it is possible to obtain films having a thickness of a few microns with a roughness of less than 1 μm, the value of J_{C} of said films being substantially improved, using higher precursor concentrations than those recommended in the prior art when carrying out a USP process. It is for this reason that the subject of the present invention is a process for the preparation of thick films of YBa₂Cu₃O_{7-y} (y≦0.08), as well as the films obtained.

The process according to the present invention consists in spraying an aqueous solution of precursors of the chemical elements to be deposited, in order to form an aerosol, in transporting the aerosol using a carrier gas from its source to a reaction region, where it comes into contact with the surface of a heated substrate, on which surface it undergoes pyrolysis, followed by an annealing operation, and it is characterized in that:
a) the precursor solution is a solution of yttrium nitrate, barium nitrate and copper nitrate, in which the total nitrate concentration is substantially equal to the saturation concentration, and the relative concentrations of the various precursors in the solution are such that 0.11≦FY≦0.28, 0.46≦FBa≦0.58, 0.2≦FCu≦0.37, FY, FBa and FCu being the respective atomic fractions of the cations;
b) the precursor solution is sprayed for a time ranging from 1 minute to 5 minutes;
c) the carrier gas is an inert gas, the flow rate of which is such that is generates a laminar flow in the environment of the forming film;
d) the pyrolysis is carried out on the heated substrate at a temperature between 800° C. and 870° C.; and
e) the annealing is carried out in oxygen, at a temperature between 850° C. and 880° C. and at least 10° C. higher than the pyrolysis temperature during a first step for a time of 1 to 2 hours, then at a temperature between 450° C. and 550° C. during a second step for a time of 0.5 to 1.5 hours.

FY denotes the N(Y)/[N(Y)+N(Ba)+N(Cu)] atomic fraction, FBa denotes the N(Ba)/[N(Y)+N(Ba)+N(Cu)] atomic fraction and FCu denotes the N(Cu)/[N(Y)+N(Ba)+N(Cu)] atomic fraction, it being understood that N(Y) represents the number of moles of Y per unit volume or per unit weight of Y, N(Cu) represents the number of moles of Cu per unit volume or per unit weight of Cu and N(Ba) represents the number of moles of Ba per unit volume or per unit weight of Ba.

The preferred precursors are copper nitrate Cu(NO₃)₂.nH₂O (n≧2.5), yttrium nitrate Y(NO₃)₃.mH₂O (m>4) and barium nitrate Ba(NO₃)₂. The respective proportions of the various nitrates in the precursor solution are preferably such that FY=0.2, FBa=0.56 and FCu=0.27, (which corresponds to the 1/2.65/1.35 Y/Ba/Cu stoichiometry). It is particularly advantageous to use a precursor solution in which the above stoichiometry is respected and in which the total nitrate ion concentration is substantially equal to the saturation concentration, which depends on the temperature. For example, for an aqueous precursor solution at room temperature, the nitrate saturation concentration is ≅0.3M.

To limit the scope of the transient effects, it is preferable to spray for a longer time than 3 minutes, more particularly longer than 4 minutes.

The substrate on which the YBa₂Cu₃O_{7-y} film is deposited may be especially chosen from MgO, LAO (LaAlO₃), STO (SrTiO₃), a nontextured Ag metal substrate and a biaxially textured Ag substrate, an yttria-stabilized ZrO₂ (YSZ) substrate or a nickel substrate.

The inert carrier gas used for transporting the aerosol may be chosen from argon and nitrogen. The combination of the choice of carrier gas flow rate, which generated a laminar flow in the environment of the forming film, of oxygen leaks from the ambient atmosphere into the reactor and of the local equilibrium associated with the decomposition of the nitrates creates, near said film, a low oxygen partial pressure, of less than 0.1 bar. This low oxygen pressure helps to place the film under conditions close to the YBa₂Cu₃O_{7-y} thermodynamic stability limits, which encourage the mobility of the species and the growth of YBa₂Cu₃O_{7-y}.

By implementing the process of the invention it is possible to obtain micron-scale films of YBa₂Cu₃O_{7-y}, y≦0.08 (i.e. films having a thickness of 1 μm to 10 μm) for which the value of J_{C} at 77 K and in the Earth's residual magnetic field is greater than 10⁶ A/cm².

The YBCO films that are obtained by the process of the invention are particularly suitable for electric current transport applications of superconductor materials and for uses in a strong magnetic field. For these applications, the materials used must be in the form of a film having a thickness of between 1 and several microns, they must have a high critical current density of at least 10⁶ A/cm² and a operating temperature above 77 K, and must be very robust. The materials obtained by the process of the invention satisfy these criteria and the low production cost makes them particularly attractive. It should also be noted that the process can be carried out continuously, unlike other deposition processes using physical techniques (laser ablation, magnetron, sputtering, MBE, etc.). The deposition of a YBCO film on a single-crystal substrate (STO, MgO, etc.) is particularly advantageous for applications in the electronics field. For the production of cables, metal substrates will be preferred.

The present invention will be explained in greater detail by reference to the illustrative examples that are described below but should not, however, be construed as being limited thereto.

The apparatus used comprised a cold-wall reactor of vertical configuration, comprising a spray zone, a transport zone and a pyrolysis zone.

The spray zone formed the aerosol-generating part. It was formed by a chamber containing a piezoelectric transducer placed in a transmitting medium, connected to an aerosol generator and operating at a frequency of around 800 kHz with a maximum ultrasonic power of 150 watts. The chamber was surmounted by a container provided with a membrane intended to receive the solution to be sprayed. The membrane was a flexible membrane, which did not degrade on contact with the precursor solution and which transmitted the ultrasound with minimum attenuation. Teflon® membranes were particularly suitable for this purpose. Said container had an inlet, connected to a flowmeter, for the carrier gas and an outlet for the sprayed liquid.

The aerosol transport zone formed the link between the spray zone and the deposition zone. It was formed by a glass nozzle connected to the other parts via suitable seals, for example made of Teflon®.

The deposition zone consisted of a chamber in which a support for the substrate was placed, YBCO being deposited on said substrate. The support was a metal plate provided with a heating means that includes a regulating device for keeping the temperature sufficiently constant throughout the duration of the operation at between 800° C. and 900° C.

After the frequency of the generator was set to a value close to the resonance frequency of the transducer, the operator adjusted the output voltage of the aerosol generator in order to vary the intensity of the geyser created at the surface of the liquid in the spray container. It was thus possible to modify the amount of sprayed aerosol while keeping the carrier gas flow rate constant. The aerosol was entrained by means of the carrier gas introduced into the spray container, through the nozzle of the transport zone from the surface of the liquid as far as the pyrolysis zone.

### EXAMPLE

Preparation of YBCO Films Deposited on an STO Substrate

Several YBCO films were deposited from a solution of precursor nitrates under the following conditions:
Substrate: STO maintained at 825° C.
Precursor: nitrates in 0.3M aqueous solution
Spray time: 4 min
Carrier gas: Argon, 3 l/min
In situ annealing:
   Gas: oxygen, 0.5 l/h
   Temperature: 850° C.
   Duration: variable duration depending on the test (0.5 h, 1 h, 2 h, 4 h, 8 h)
In situ oxygenation:
   Gas: oxygen, 3 l/min
   Temperature: 525° C.
   Duration: 30 min.
      Analysis of the Deposited Films Obtained

Each film obtained was characterized by an inductive magnetic measurement in a magnet field of less than 10 Oe. This magnetic measurement, well known and conventional in the field, consisted in measuring the AC susceptibility of the specimen as a function of temperature. The in-phase component λ′ was used to determine the critical temperature T_{C}. The in-quadrature component λ″ gave the critical current determined at the corresponding λ″ maximum at full penetration of the magnetic field into the film. Knowing the coupling coefficient α of the coil, the coil current I inducing the penetration field and the thickness e of the film, the critical current (αI/e) was deduced therefrom at a given temperature.

Other measurements were carried out by a four-electrode resistive method. This resistive method, carried out on a microbridge 3 mm in length and 100 μm in width, used a 10 μA pulsed current. The measurements were made by lowering the temperature from 300 to 80 K. The resistivity ratio between 300 K and 100 K was around 3.2, indicating good film quality. The T_{C} measurements confirmed the magnetic susceptibility measurement as regards the critical temperature and showed that the width of the transition was ΔT_{C}=0.7 K defined at 80% of the start of the transition, also called the “onset”, and 20% of the end of the transition, also called the “offset”. According to this criterion frequently used by those skilled in the art, the films were of very high quality.

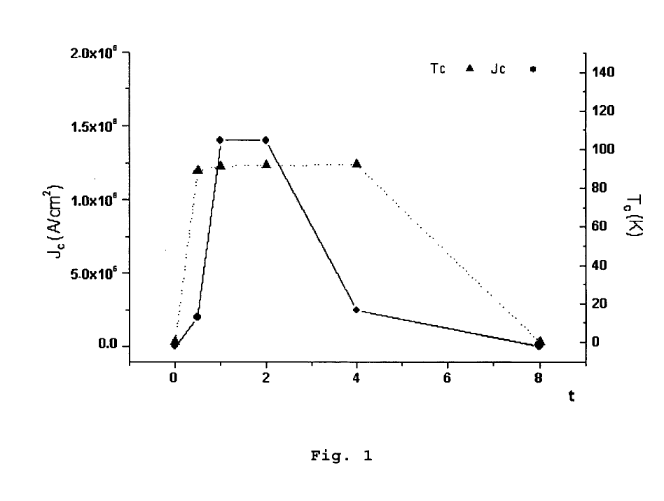

The results obtained are given in the appended FIG. 1. In this figure, the curve indicated by the ▴ symbol represents the variation in T_{C} as of function of the annealing time at 850° C. and the curve indicated by the ● symbol shows the variation in J_{C} as a function of the annealing time. The scale for the J_{C} values is shown in A/cm² on the left-hand y-axis, the scale for the T_{C} values is shown in K on the right-hand y-axis and the annealing time t (in hours) is indicated on the x-axis.

These results show that the unannealed films are not superconducting • although having the appropriate chemical composition. The annealing is necessary to induce the crystallinity suitable for the superconducting phase to appear and for the organization of the grains needed for current flow. After annealing for 0.5 h, the critical temperature is 89 K and the corresponding critical current density does not exceed 10⁵ A/cm² at 77 K. After annealing for one hour, Tc increased very slightly (by 2%) while the critical current density increased by a factor of 10, now exceeding 10⁶ A/cm².

In this annealing phase, the crystallinity was considerably improved, as analysis of the change in texture showed. The texture was characterized by grains in the form of platelets, which could be placed flat on the surface of the substrate, these being denoted by c_{⊥} in order to remind the reader that their crystallographic c-axes were perpendicular to the substrate, and grains laid on the edge, denoted by a_{⊥}. It is known that the best properties are observed when all the grains are c_{⊥}. Texture analysis was used to determine the volume fraction (a_{⊥}/c_{⊥}) of the a_{⊥} grains. The analysis was carried out using the method described in the thesis of D. Chateigner (D. Chateigner, Doctoral Thesis of the University of Grenoble, 1994). This method consisted in measuring the intensities diffracted by the (102)-(012) planes observed in rotation mode φ (also called φ scan) at the angle of inclination λ=57° (Ic_{⊥}) and λ=33° (Ia_{⊥}) and in taking the ratio

$$( {a}_{⊥} / {c}_{⊥} ) = \frac{2 \sum Ia ⊥ ( χ , φ )}{2 \sum Ia ⊥ ( γ , φ ) + \sum Ic ⊥ ( χ , φ )} .$$

This ratio (a_{⊥}/c_{⊥}) which exceeded 60% for t=0 h was reduced to 5% after annealing for one hour and remained constant thereafter. The c_{⊥} grains had orientations in the plane of the substrate which were not arbitrary, as the φ scan studies demonstrated. The relative disorientation was deduced from the line width in this measurement mode. The c_{⊥} grains were also disoriented relative to the normal to the substrate, this being able to be assessed by studying the profile of the (001) lines in ω rocking mode (the rocking curve). The measurement of the width of this profile gave the disorientation of the c_{⊥} grains relative to the normal to the surface. Thus, the disorientation of the c_{⊥} crystallites along the c axis was less than 0.5° and the grains were disoriented by less than 3° in the plane of the substrate. These remarkable values remained stable for one and two hours of treatment. It is these values that give the film the high critical current rarely observed for such film thicknesses.

After 2 hours of annealing, the critical current density J_{C}, and then the T_{C}, decrease because of contaminations by the substrate, which are more frequent the higher the annealing temperature and the lower the duration of the annealing.

It is clearly obvious that the increased value of J_{C}, of around 10⁶ A/cm², is obtained only for annealing of 1 to 2 hours.

Analyses using scanning electron microscopy (SEM) and transmission electron microscopy (TEM) have showed that most of the crystallites were well oriented with their c axes perpendicular to the substrate. The substrate/film interface was plane and amounted to a few atomic planes. It should be noted that there are, although in small quantity, crystallites oriented along the a-axis perpendicular to the substrate, in agreement with the texture analysis described above. This analysis of a cross section of the film also revealed porosity that the annealing treatment progressively removed.

The current profile induced in the film (5 mm×5 mm specimen) was analyzed by mapping the induced yield detected by a Hall microprobe moved over the specimen at a temperature of 77 K. The induced field was then translated in terms of critical current (using the Bean law, where known to those skilled in the art) and the mapping represented by lines of levels every 0.5 A/cm². The fact that these lines are continuous proves that the grains are very well connected. On the border of the specimen there are zones of lower current where the field penetrates. The core of the specimen possesses a region of very high critical current, exceeding 3 MA/cm², whereas it remains greater than 1.1 MA/cm² in the low-current regions.

1. A process for the preparation of a micron-scale film of YBa₂Cu₃O_{7-y} (y≦0.08) on a substrate, which consists in spraying an aqueous solution of precursors of the chemical elements to be deposited, in order to form an aerosol, in transporting the aerosol using a carrier gas from its source to a reaction region, where it comes into contact with the surface of a heated substrate, on which surface it undergoes pyrolysis, followed by an annealing operation, characterized in that:
a) the precursor solution is a solution of yttrium nitrate, barium nitrate and copper nitrate, in which the total nitrate concentration is substantially equal to the saturation concentration, and the relative concentrations of the various precursors in the solution are such that 0.11≦FY≦0.28, 0.46≦FBa≦0.58, 0.2≦FCu≦0.37, FY, FBa and FCu being the respective atomic fractions of the cations;
b) the precursor solution is sprayed for a time ranging from 1 minute to 5 minutes;
c) the carrier gas is an inert gas, the flow rate of which is such that is generates a laminar flow in the environment of the forming film;
d) the pyrolysis is carried out on the heated substrate at the temperature between 800° C. and 870° C.; and
e) the annealing is carried out in oxygen, at a temperature between 850° C. and 880° C. and at least 10° C. higher than the pyrolysis temperature during a first step for a time of 1 to 2 hours, then at a temperature between 450° C. and 550° C. during a second step for a time of 0.5 to 1.5 hours.

2. The process as claimed in claim 1, characterized in that the copper precursor is Cu(NO₃)₂.nH₂O, n≧2.5.

3. The process as claimed in claim 1, characterized in that the yttrium precursor is yttrium nitrate Y(NO₃)₃.mH₂O, m≧4.

4. The process as claimed in claim 1, characterized in that barium precursor is Ba(NO₃)₂.

5. The process as claimed in claim 1, characterized in that the respective proportions of the various nitrates in the precursor solution are such that FY=0.2, Ba=0.56 and Cu=0.27.

6. The process as claimed in claim 1, characterized in that the substrate on which the YBa₂Cu₃O_{7-y} film is deposited is chosen from MgO, LAO (LaAlO₃), STO (SrTiO₃), a nontextured Ag metal substrate and a biaxially textured Ag substrate, or an yttria-stabilized ZrO₂ (YSZ) substrate or a nickel substrate.

7. The process as claimed in claim 1, characterized in that the carrier gas used for transporting the aerosol may be chosen from argon and nitrogen.

8. The process as claimed in claim 1, characterized in that the spraying in step b) is carried out for a time of greater than 3 minutes.

9. A substrate coated with a micron-scale film of YBa₂Cu₃O_{7-y} (y≦0.08), obtained by a process as claimed in claim 1.

10. A substrate coated with a micron-scale film of YBa₂Cu₃O_{7-y}(y≦0.08), obtained by a process as claimed in claim 2.

11. A substrate coated with a micron-scale film of YBa₂Cu₃O_{7-y}(y≦0.08), obtained by a process as claimed in claim 3.

12. A substrate coated with a micron-scale film of YBa₂Cu₃O_{7-y}(y≦0.08), obtained by a process as claimed in claim 4.

13. A substrate coated with a micron-scale film of YBa₂Cu₃O_{7-y}(y≦0.08), obtained by a process as claimed in claim 5.

14. A substrate coated with a micron-scale film of YBa₂Cu₃O_{7-y}(y≦0.08), obtained by a process as claimed in claim 6.

15. A substrate coated with a micron-scale film of YBa₂Cu₃O_{7-y}(y≦0.08), obtained by a process as claimed in claim 7.

16. A substrate coated with a micron-scale film of YBa₂Cu₃O_{7-y}(y≦0.08), obtained by a process as claimed in claim 8.
